(19) United States
(12) Patent Application Publication
(10) Pub. No.: US 2004/0168166 A1
(43) Pub. Date: Aug. 26, 2004

(54) Network adapted for flexible media integration

(76) Inventors: Stefan Abramowski, Aachen (DE); Heribert Baldus, Aachen (DE); Tobias Helbig, Aachen (DE); Wim J.J. Stut, Eindhoven (NL); Huibert Henk Eggenhuisen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/739,372

(22) Filed: Dec. 17, 2003

Related U.S. Application Data
(63) Continuation-in-part of application No. 09/580,168, filed on May 30, 2000.

(30) Foreign Application Priority Data
May 29, 1999 (DE) 19924795.1

(51) Int. Cl. G06F 9/44

(52) U.S. Cl. 717/168; 717/171; 717/176; 717/105

(57) ABSTRACT

A network system supports distributed applications that execute on networked devices. The system provides a uniform modeling and implementation method and system that are particularly suited to use in digital in-home networks. For example, the invention may be applied to support the interoperation of various digital consumer electronics devices, such as TV, receivers, tuners, digital storage, and a personal computer interconnected by a home network. The method and system help to realize the potential of networked devices by providing for rich interoperation that combines the functionalities of different devices and allows for expansion and upgrade by providing a uniform scheme for controlling the interaction among the attached devices.

### BACKGROUND

Many have discussed the idea of a networked home where devices from personal computers to telephones and televisions and even refrigerators and ovens are easily able to communicate with each other. In such a networked home, owners may use a PDA (personal digital assistant) or a phone keypad to control the operation of an oven or take pictures on a home security camera. A cell phone might be used to turn on lights or access picture files on a personal computer and send them to a live-in elderly relative's television set. A DVD upstairs could play on a television set downstairs and simultaneously in a window on a personal computer. Many see such networks as having a huge potential to enhance the utility and enjoyment of otherwise independent devices. Such a network could provide not only for the connection of media sources to various output devices, but also for the intermediate conditioning of signals, for example a decoder running on the personal computer could decode a video signal from a broadcast receiver and send the output stream to a television. Supporting such interoperation may be a complex enterprise, particularly from a software standpoint, because of the difficulties of providing for the interoperation of devices with various characteristics. An example of such a networked system is described in Reif Steijnmetz (Hrsg.): “Kommunikation in verteilten Systemen (KiVS),” 11.ITG/GI-Fachtagung, Darmstadt, Mar. 2-5, 1999; Stephan Abaramowski, Heribert Baldus, Tobias Helbig: “Digitale Netze in Wohnungen—Unterhaltungselecktronik im Umbuch,” pp. 340-351.

### SUMMARY OF THE INVENTION

The invention relates to distributed application programs running on networked devices. More particularly, it relates to a uniform modeling and implementation framework suitable for many varied applications in digital networks including varied mixes of networked devices.

The invention stems from the idea that when a user wants to do something, he first develops an abstract idea of what he wishes to accomplish apart from the equipment available for doing it. In a simple example, the user decides to watch a TV broadcast and then must translate that abstract wish into a desire to see something happen with regard to available equipment in his vicinity, namely, the activation of a TV. As may be familiar to many TV users, even the simple matter of turning on a TV can be a daunting enterprise when a complex entertainment system is built around it. There may be a satellite dish, a tuner, a cable connection, a video source, a surround sound system as well as speakers and headphones connected to various devices themselves. Also audio decoders, video decoders, tape players, recorders, etc. may exist in a large potential tangle of information and command channels. The translation of the wish for an activity into a real process that satisfies that wish can be a complex enterprise. The abstract activity the user desires still has some meaning apart from the equipment that provides it. Furthermore, the abstract activity can follow the user around a space, for example, from room to room if the user wants to bring the activity along with him. That is, he'd like to watch TV in the kitchen and then continue the activity in the bedroom. But bringing along an activity as a user moves about involves a new process of translating the abstract notion of the activity into the activation and connection and setting of various pieces of equipment.

The invention, in a sense, models the operation and control of networked devices so as to give meaning and utility to the abstract notion of an activity. For example, the common features of an activity may, in a user interface, be given a common look set of controls so that “play” always uses the same (or similar) sort of control. Touchscreen user interfaces, such as portable remote controls can provide such similar appearance and behavior. For another example, the performing of an activity in one location is begun by deriving a particular instance of a software process from a general definition of that process that is associated with the abstract notion of the activity. Process elements associated with the specific instance of the activity may include particular functions associated with the particular pieces of equipment to be used to allow the abstract activity to be realized in a given location where those pieces of equipment are located. But general aspects of the software process required for the desired activity are common to all similar kinds of equipment environments. The specific and general elements may be encapsulated by separate software components, where the specific elements constitute one or more derived objects from one or more general classes which provide the common elements required to realize a real world process. When a new specific instance of a desired process is generated at a new location, the general aspects may be persisted from the old location to the new location so that the abstract activity may be considered to follow the user from old location to the new location.

### BRIEF DESCRIPTION OF THE DRAWINGS

FIG. 1A illustrates an in-home network system which is an example of an environment suitable for using the present invention.

FIG. 1B illustrates relationships between various objects in a software system of a network.

FIG. 2 illustrates notation used to relate objects of a software system and their relationships.

FIG. 3 illustrates the components that give rise to an abstract process and the components' relationships to objects in the software system of FIG. 1B.

FIG. 4 illustrates relationship between an instance of a broadcast process and its relationship to associated class objects.

FIG. 5 illustrates interfaces generated in the context of FIG. 4.

FIG. 6 illustrates a physical environment and a map representation thereof for the example of a broadcast process.

FIG. 7 illustrates an example of the generation of a broadcast process by way of a message sequence diagram.

FIG. 8 illustrates a user interface for controlling the software system of the invention according to an embodiment.

### DETAILED DESCRIPTION OF THE EMBODIMENTS

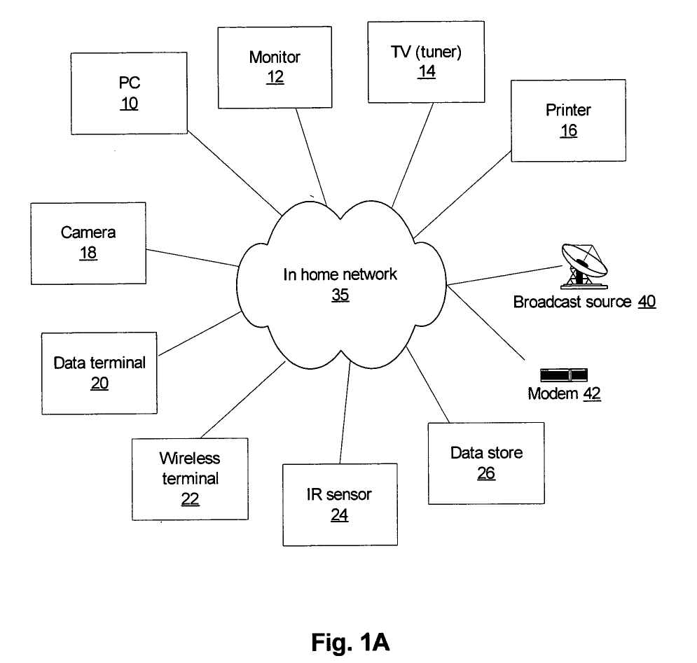

Referring to FIG. 1A, a networked system for purposes of illustrating the invention is an in-home digital network (IHDN) with various digital consumer electronics devices, such as televisions 14, digital storage 26, personal computers 10, monitors 12, printers 16, cameras 18, data terminals 20, wireless terminals 22, sensors 24, etc. All are interconnected via a network 35. The network 35 may include one or more servers (not shown separately). The network 35 may be connected to various outside data systems such as a broadcast data channel 40 and Internet modem 42. The foregoing are only by way of examples and are not intended to be comprehensive nor limiting of the invention.

The IHDN supports applications, each of which may make use of several available devices, combining their functionalities to provide some overall functionality associated with an application. The invention implements and controls, in a uniform way, the many different types of applications that can be executed on the connected devices. The scheme provided is called the “activity design and implementation model.”

The term “activity” is applied to a software component that offers functions for creating, modifying and controlling resources and their interconnection as required for desired specific activities such as viewing a digital video broadcast or videoconferencing. An activity denotes the functionality of the respective application in a way that is independent of the specific devices involved in any particular instance of a special activity or the locations of the devices involved. Thus, the activity model isolates certain application logic from the physical devices that may be involved. This allows devices to be allocated dynamically to support a specific activity such as videoconferencing (audio or video-broadcast, or monitoring and supervision).

The activity model introduces a set of application program interfaces (APIs) that offer define methods for configuring and controlling the related application(s) so that all applications executing on the IHDN can be accessed and controlled in a common way—that is, by way of a uniform program interface. Each activity has an interface to an overall activity manager that administers all activities that are activated in the IHDN system. Each activity has a uniform component, called a player, which controls the transfer of data through the underlying network.

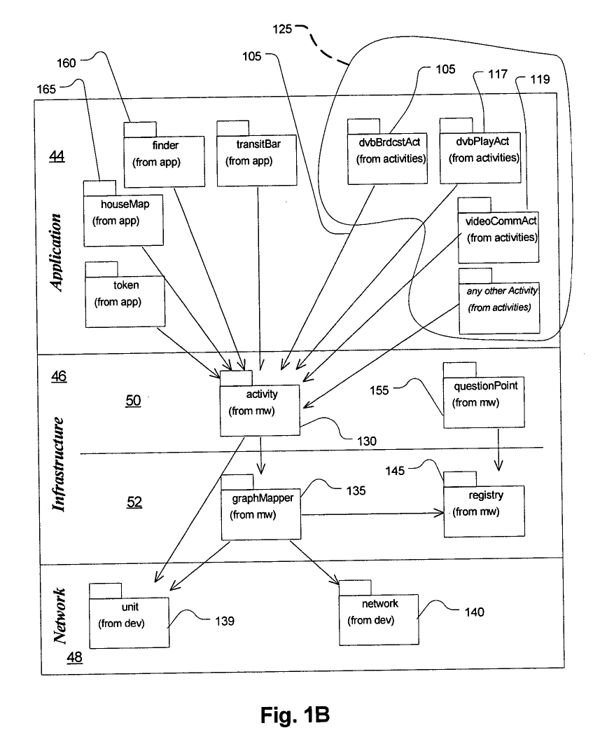

A special activity is a software component that handles an application and uses functions for manipulating the devices employed for the activity. The special activity extends only to a software representation of the physical components leaving it to further underlying software layers to handle the specifics of the hardware elements. Referring to FIG. 2, the software levels that form that basis of the software system include a first software level 44 called the application level, a second level 46 called an infrastructure level, and a third level 48 called a network level. The second level 46 may be further divided into to further sublevels 50 and 52, the former being for interfacing with applications and the latter being for general infrastructure management.

The following provides an overview of the software architecture in the context of a particular example. Referring to FIG. 1B, software packages (e.g., 105) are shown as file folder icons (e.g. 105) and their mutual dependencies are indicated as arrows (e.g. 110). Each package encapsulates a set of classes that are logically grouped together. An arrow from package A to package B indicates that package A depends on or uses package B.

The packages enclosed by the broken line boundary 125 include examples of applications, each corresponding to one type of specific activity. Again, the specific activity is a particular implementation of a broader activity. For example, a broadcast DVB viewing special activity corresponds to package dvbBrdcstAct 105, which contains the classes that are specific to the broadcast DVB viewing special activity, the more generic classes being contained in the package “activity” 130. The packages and associated special activities in the group enclosed by the broken line 125 are:

dvbBrdcstAct 105 broadcast DVB viewing

dvbPlayAct 117 play-back of a recorded DVB program

videoCommAct 119 video communication

The list is not comprehensive and any kind of software process can be added according to the same scheme. Although each special activity is different, all have features in common. The commonalities are encapsulated in the common package activity 130. The package activity 130 offers an object-oriented framework; a set of interrelated classes that work together. Each particular special activity package inherits methods, interfaces, etc. from the activity package after details specific to the special activity are filled in. For example, the package activity offers abstract class Activity which is refined in package dvbBrdcstAct by subclass dvbBrdcstAct. Thus, the abstract class Activity can be regarded as part of an infrastructure, which defines the interfaces to other infrastructure components as well as the interfaces for manipulating activities at the application level.

A group of support packages that are not specific to any activity or special activity are illustrated in the application level 44 outside the boundary 125. For example, an application level package supports interconnection. Each Application may use different devices and network resources and the interconnections required define a graph, which is mapped to physical devices and network connections. This mapping is handled by a graph mapper in package graphMapper 135. The graph mapper uses a registry to find out which subunits exist in the system. It then uses an overall resource manager to determine the subunits that are available. The graph mapper also contacts the network to obtain a free channel and requests unit managers to connect the subunits to each other or to the network.

To function together, several objects must know what's going on in the system. For example, each must determine which activities are currently established in the system, which locations exist (e.g., rooms in the home), and which units are in each location. The QuestionPoint package 155 offers various operations for various such questions that can be asked about the system and its current state. The QuestionPoint isolates the objects that ask the question from the underlying class structure.

On the application level, all activities can be controlled via a uniform set of interface commands: including start, stop, redirect to other places, etc. These commands may be available directly through a user interface or accessed indirectly through other processes. Examples include two basic interaction forms: a visual, screen-based form and a token. The screen-based form includes a houseMap 165 and a finder 160. For each of these, a corresponding package 165, 160 has been defined. Note that these packages depend on the package activity 130, but not on the specific special activity, such as the one for broadcast DVB viewing: dvbBrdcstAct 105. Both forms merely manipulate objects of abstract class Activity without any dependency on the particular features of a special activity manipulated by it such as like dvbBrdcstAct 105. This allows new kinds of special activities to replace current ones or to be added without changing the controlling software.

The network level 48 contains packages representing terminals 139 and network units 140. These packages encapsulate software specific to the particular network and terminal components such as network servers, channels, media devices such as televisions, etc. Also, terminals may have certain subfunctions which may be handled by sub-packages (not shown separately) that are dependent on their respective network level packages. An example is a tuner function of a television terminal.

The following sections describe the activity 130 and dvbBrdcstActivity 105 packages. In the description, the following conventions are used: class names start with an upper-case letter (e.g. class Activity), whereas object names start with a lower-case letter (e.g. myActivity). Referring to FIG. 2, in class diagrams to be discussed below, certain graphic conventions are used to describe relationships between classes. The relationship between object A 200 and object B 215 is indicated by the symbol 210 which means A consists of B or, in other words, B is a part of A. The relationship between object C 220 and object D 235 is indicated by the symbol 230 which means C is a species of D or, in other words, C inherits from D. The relationship between object E 240 and object F 245 is indicated by the symbol 250 which means E is dependent on F or, in other words, E uses F.

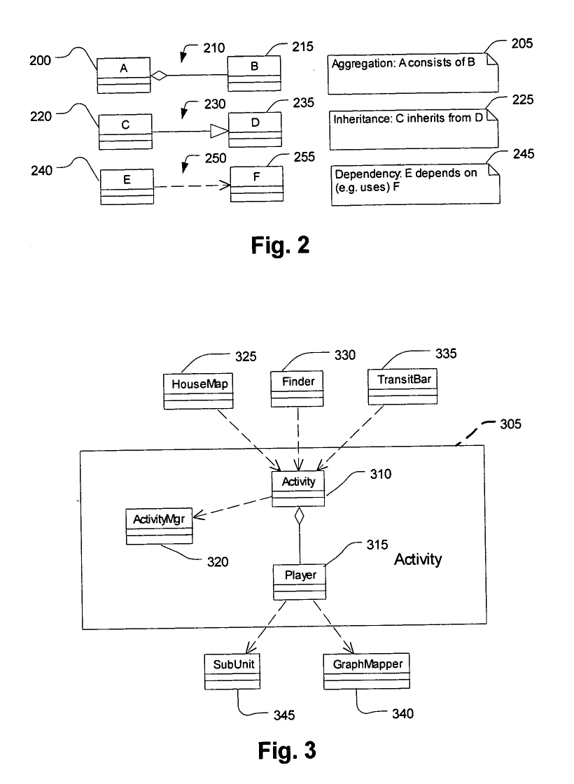

Referring now to FIG. 3, classes within the package Activity 130 are shown within the dashed rectangle 305. The following sections describe the classes in package activity in more detail. Class Activity 310 is an abstract class that encompasses the common aspects of the various types of special activities that a user may wish to generate. For each specific special activity 310, a subclass must be defined. For example, subclass DvbBrdcstAct defines the structure and behavior of the broadcast DVB viewing special activity. The player 315 is a part of activity 305. All activities have at least one player, a uniform component that is used for control of the transfer of multimedia data streams through any underlying network. Within a single special activity, there may be several player objects 315 although only one is illustrated. Each player 315 would handle a particular media stream. The special activity object holds references to associated player objects. ActivityMgr 320 registers all active special activities and offers various information concerning the properties of active special activities. Finder 330 presents all available special activities via different interface commands so that other software components can access such special activities. HouseMap 325 provides a graphical user interface enabling a user to command the system. GraphMapper 340 provides functions including accessing a registry to find out which subunits exist in the system.

A user may indicate, via a user interface, a desire to take an activity along with the user when changing a location. The activity object is requested to change its playout location. For example, the DVB broadcast activity can be moved by requesting that it stop playing in the living room and continue in the kitchen. This request is forwarded to the player object of the activity. Note that the applications that control activities (such as the houseMap) need not know the player object(s) of an activity; they may merely call methods offered by the activity object.

A player 315 forms a part of each activity. It is responsible for the processing of a data streams (playback, record, etc). Class Player is an abstract class; only instances of derived classes (such as DvbBrdcstPlayer) perform the associated function. Upon creation of an activity, the player contacts the graphMapper to build a graph for mapping it to physical resources and network connections, essentially a type of session management. Once the graph has been generated, the player implements stream control functionality for example, zapping or play/pause, by calling methods of the appropriate subunits (for example, tuner.tune( ). When controlling a rudimentary, non-synchronized stream, the player object may interact only with the source subunits in the graph to implement control. In more complex situations, the player may also interact with other subunits in the graph (according to a more complex protocol).

If an operation of a player object is invoked, this will affect all its playout locations. If this is not desired, two independent activities may be started. The activity manager manages the set of activities and offers an interface for querying this set. For example, it offers a method for obtaining an overview of all ongoing activities. After creation, each activity registers with the activityManager. Correspondingly, each activity deregisters when it terminates.

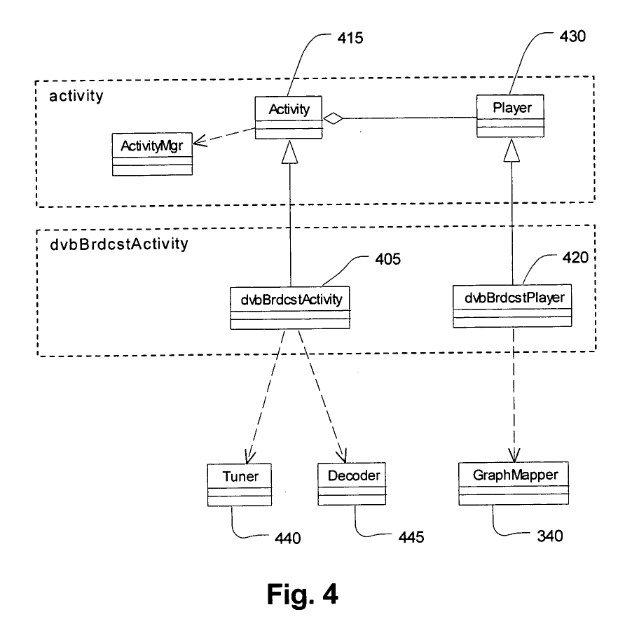

The following is an illustration of the process of realizing a concrete special activity. In this illustration, the Digital Video Broadcast Activity, is generated as an instance of the Activity framework by adding subclasses. Referring to FIG. 4, which is a class diagram, the dvbBrdcstActivity object 405 inherits from the general, abstract class Activity 415. The corresponding dvbBrdcstPlayer object 420 inherits from the general class Player 430. The dvbBrdcstPlayer object 420 accesses classes that are responsible for the particular details of the device or its internal elements, for example, a tuner 440 and decoder 445 of a player terminal (not shown separately).

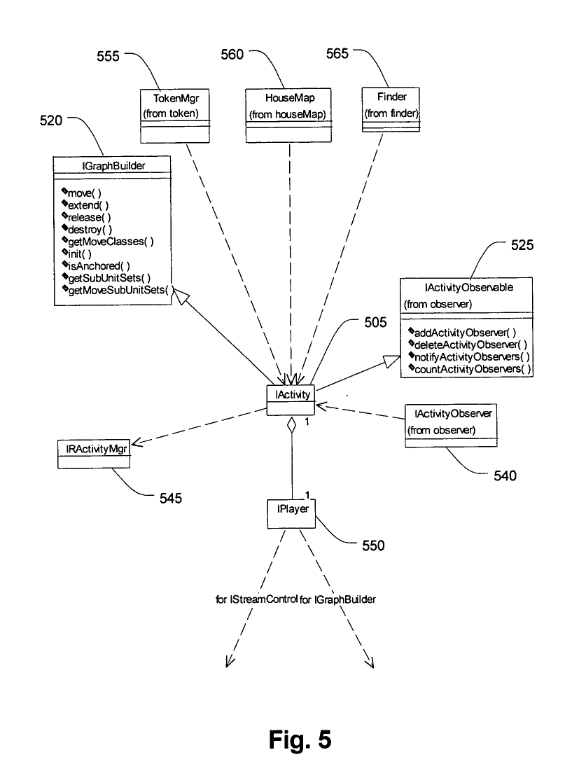

The resulting interface offered by each activity is illustrated in FIG. 5. It includes the interfaces inherited from GraphBuilder 520 and ActivityObservable 525. Also shown are a TokenMgr 555 for an example user interface type (not described in detail) call a token, Housemap 560, Finder 565, IActivityMgr 545, IPlayer 550, and IActivityObserver 540.

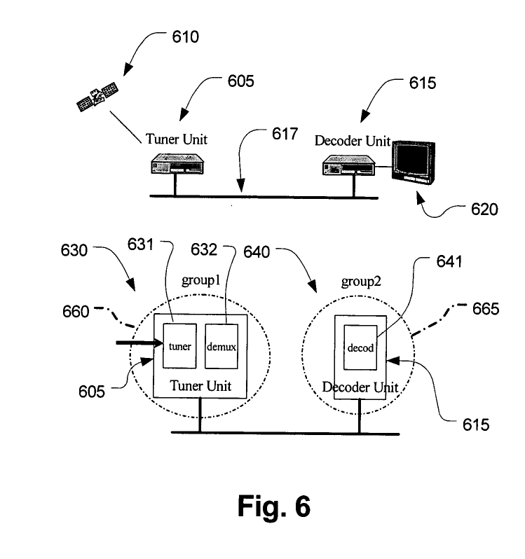

The following is a scenario for watching TV via DVB broadcast process. An example physical configuration of devices is illustrated in FIG. 6. The system has two set-top boxes 605 and 615. One set top box 605 is connected to a satellite 610 and contains a tuner 631 and a demux 632. The other set-top box 615 is connected to a normal TV 620 and contains a decoder 641. Both set-top boxes 605 and 615 are connected to a network 617. The graph to be realized contains two groups 660 and 665 which represent the set-top boxes 605 and 615 respectively. The first group has the tuner 631 and the demultiplexer 632 and the second group has the decoder 641. Because each set-top box 605 and 615 provides an execution environment, each set-top box 605 and 615 forms its own group 660, 665.

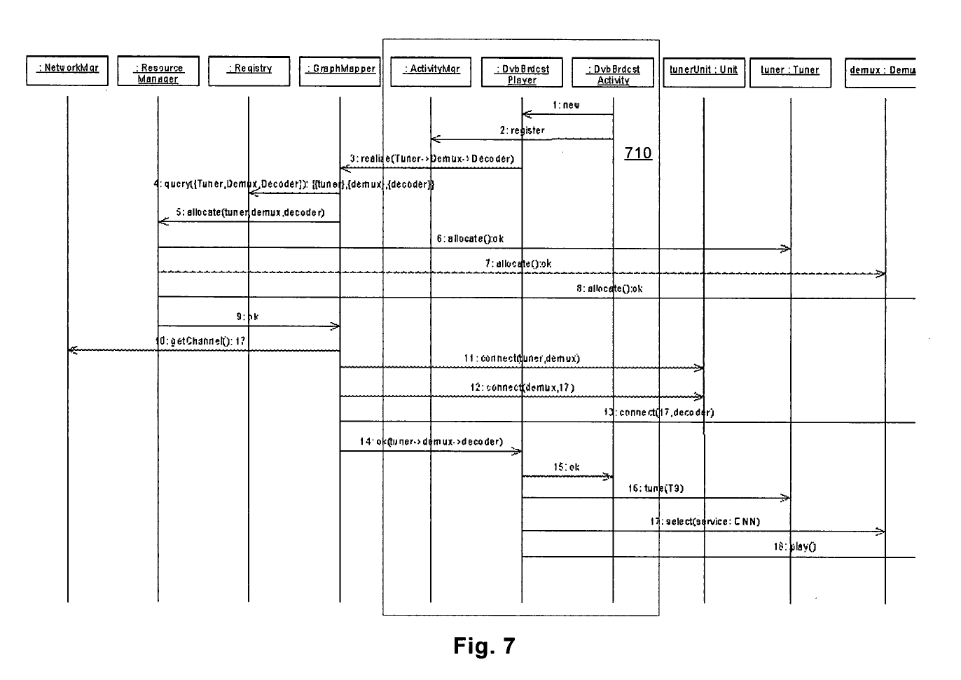

FIG. 7, a message sequence diagram, illustrates the interaction between the functional entities for the case of DVB viewing. The following events occur in sequence in this example. Note, the boundary 710 indicates the components that are directly related to the activity model.

1. The dvbBrdcstActivity creates a new dvbBrdcstPlayer object.

2. The dvbBrdcstActivity registers itself with the activityManager.

3. The dvbBrdcstPlayer gives a description of the desired graph to the graphMapper.

4. The graphMapper asks the registry for a tuner, a demux, and a decoder. The registry returns references to such subunits. The graphMapper selects a tuner, a demux, and a decoder.

5. The graphMapper asks the resourceManager to reserve the tuner, the demux, and the decoder.

6-8. The resourceManager contacts the corresponding wrapper objects to know whether the subunits are available and to reserve them.

9. The resourceManager informs the graphMapper that it has succeeded.

10. The graphMapper gets a free channel for isochronous traffic from the networkManager

11. The graphMapper asks the tunerUnit to connect the tuner to the demux. (For doing so the graphMapper needs to know the unit managers. It could do so by asking the subunits to return (a pointer to) their unit managers. This is not shown in the diagram.)

12. The graphMapper asks the tunerUnit to connect the demux to the channel.

13. The graphMapper asks the decoderUnit to connect the decoder to the channel.

14-15. The dvbBrdcstPlayer is informed by the graphMapper about the successful build up of the graph(14). The graphMapper forwards this information to the dvbBrdcstActivity (15).

16-18 In order to start TV watching, the dvbBrdcstPlayer sends corresponding commands to the wrapper object for tuner (16), the demux (17), and the decoder (18).

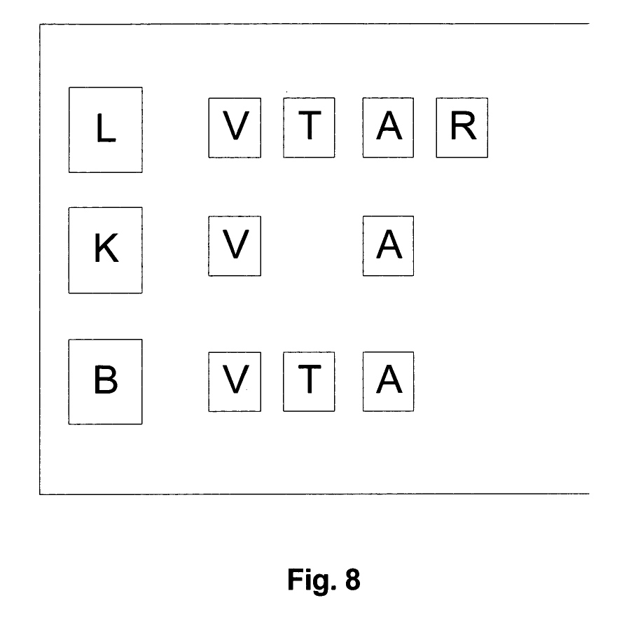

Referring to FIG. 8 a user interface display that may be created using a CRT with a touch-screen, for example. The display indicates locations K (kitchen), B (bedroom), and L (living room) having equipment connected to a network (not shown). For each location, activities that are available in those rooms are also identified. The possible activities shown include V (video conference), T (television), A (radio), and R (recording).

It should be clear from the above description that the software that forms the various layers can be centralized or distributed. For example, one implementation may centralize all the intelligence of the system in one or more network servers and employ dumb terminals. At the other end of the spectrum, the processing may be done on a more distributed basis with application-specific processes being supported by the various network terminals with only basic network support being provided by centralized processors.

1. A software system for controlling networked appliances, comprising:
a network system with terminals including media input and output devices and effective to receive media data from a media data source and output said media data at at least one of said terminals;
said network with terminals including at least one processor programmed to provide an operating system and to support applications;
said operating system having application level software with control applications that provide support to applications;
said operating system having an activity component that provides processes that are common to different ones of said applications;
said activity component including a player component configured to manage media data streams and a manager component for registering all active applications;
said operating system including a user interface component to receive commands from a user to perform an function involving said media data and in response thereto generate a software process part of which is derived from said activity component and part of which is derived from a special application process, and registering said software process with a registering component.
